(19) United States
(12) Patent Application Publication
(10) Pub. No.: US 2024/0281826 A1
(43) Pub. Date: Aug. 22, 2024

(54) CARBON EMISSIONS AND POWER FOOTPRINT MANAGEMENT SYSTEM

(71) Applicant: The Boston Consulting Group, Inc., Boston, MA (US)

(72) Inventors: Tristan Mallet, Paris (FR); Victor Aubin, Paris (FR); Yasmina Daoudi, Paris (FR); Mouhcine Berrada, Paris (FR); Adrien Duthoit, Nanterre (FR)

(21) Appl. No.: 18/172,572

(22) Filed: Feb. 22, 2023

(51) Int. Cl. G06Q 30/018; G06Q 50/06

(52) U.S. Cl. CPC G06Q 30/018; G06Q 50/06

(57) ABSTRACT

Described are techniques for measuring carbon equivalent emissions from digital and technology assets including software. The techniques include a carbon emissions data analytics engine that receives a digital and technology assets design and parameters and data including system consumption data and historical usage data logs, models a baseline operation of the digital and technology design and quantification of baseline emissions and power consumption, generates by an abatement scenario building and assessment engine, at least two abatement scenario models, provide at least one comparison of the at least two abatement scenario models, generate a carbon equivalent emission data analytics recommendation, based on the least one comparison, and causes display of the carbon equivalent emissions data analytics recommendation

### BACKGROUND

This disclosure relates to CO₂e and power footprint tracking systems.

Many organizations rely on tracking systems to manage different types of aspects of their business platforms, from manufacturing processes to human resources. One type of tracking system is a carbon emission tracking system. Carbon emissions tracking systems can be used to support an organization's initiative for limiting the environment impact of such platforms. For example, organizations may track carbon emissions in order to manage sustainability data and report on their carbon footprint. Many organizations seek to reduce their Carbon Dioxide Equivalent or CO₂e (hereinafter CO2e) emissions.

CO2e is defined as a standard metric measure that is used to compare global warming potential of various greenhouse gases over a specified time period. Examples of greenhouse gases include carbon dioxide, methane, nitrous oxide, sulfur hexafluoride, hydrofluorocarbons, perfluorocarbons, chlorofluorocarbons and nitrogen tri-fluoride, among others.

In particular, organizations may seek to reduce Carbon Dioxide Equivalent or CO₂e (hereinafter CO2e) emissions from digital and technology assets and applications, which currently represent about 4% of the world's total emissions. These total emissions are expected to increase, as the use of digital and technology assets increase.

### SUMMARY

Various aspects of the technology described herein are generally directed to systems, methods, and computer storage media, for among other things, providing carbon emissions data analytics recommendations (“recommendations”) using a carbon emissions data analytics engine (“analytics engine”) in a carbon emissions management system.

Described herein are techniques for delivering precise and smart quantification and reduction decision support for CO2e emissions for digital and technology assets.

According to an aspect, computer system for measuring carbon equivalent emissions from digital and technology assets including software, the computer system including one or more computer processors; and computer memory storing a carbon emissions data analytics engine that includes computer-useable instructions that, when executed by the one or more computer processors, cause the one or more computer processors to receive a digital and technology assets design and parameters and data including system consumption data and historical usage data logs, model a baseline operation of the digital and technology design and quantification of baseline emissions and power consumption, generate by an abatement scenario building and assessment engine, at least two abatement scenario models, provide at least one comparison of the at least two abatement scenario models, generate a carbon equivalent emission data analytics recommendation, based on the least one comparison, and cause display of the carbon equivalent emissions data analytics recommendation.

Other aspects include computer implemented methods and non-transitory computer storage media.

One or more of the above aspects may include one or more of the above features or other features disclosed herein.

The definitions of scope emissions are provided, and the computer system provides models for scope 1 and 2 which are emissions that are owned or controlled by a company, and scope 3 which are emissions are a consequence of activities of the company but occur from sources not owned or controlled by the company. An analytics recommendation engine that produces at least one recommendation that addresses scope two and scope three emissions.

The carbon emissions data analytics engine receives inputs from one or more input sources and models the inputs by hardware operation based on digital functionalities including at least one of algorithms, applications, and operating systems.

The carbon emissions data analytics engine models digital and technology assets including software operation, by modelling process functions, allocation functions, transfer functions, and power functions.

The carbon emissions data analytics engine receives the model of the digital and technology assets including software operation including process functions, allocation functions, transfer functions, and power functions, which are inputs to a baseline quantification and the abatement scenario building and assessment engine.

The abatement scenario building and assessment engine defines abatement levers and abatement scenarios, and fine-tunes the digital and technology assets operation determined by a baseline quantification engine, in response to modeled abatement scenarios.

The carbon emissions data analytics engine further includes a decision-support engine that provides comparisons of abatement scenarios and impact potentials and provides continuous monitoring of the digital and technology assets. The decision-support engine formulates one or more recommendations for improvement of the digital and technology assets.

The carbon emissions data analytics engine provides user interfaces that renders a layered baseline system architecture that includes a plurality of layers, including at least a hardware layer, an operating system container layer, and an application layer.

One or more of the above aspects may provide one or more of the following advantages.

Many gaps that currently prevent organizations from getting smart quantification and therefore being able to make robust CO2e abatement decisions are avoid. The aspects provide a rigorous, holistic, and fully variable framework to link functional and applicative structures and parameters with power consumed by hardware supporting these functionalities and applications, i.e., the presence of a logical model of how the virtual assets and physical assets interact. The presence of this information and data regarding provide insight into how individual components of the digital and technology assets behave, e.g., software resource usage, hardware power consumption depending on load.

### DESCRIPTION OF THE DRAWINGS

FIG. 1 is a block diagram of a carbon emissions management system;

FIG. 2 is a block diagram of an instantiated baseline system;

FIG. 3 is an exemplary flow diagram for the carbon emissions management system;

FIGS. 4A-4C are diagrams showing exemplary data structures;

FIGS. 5A-5F are diagrams showing outputs from the carbon emissions management system;

FIG. 6 is a block diagram of an exemplary distributed computing environment; and

FIG. 7 is a block diagram of an exemplary computing environment.

### DESCRIPTION

### Overview

Described below are techniques to assist organizations in measuring, controlling, and reducing their carbon emissions and energy costs that are driven by digital and technology assets, whether the organizations are providers or consumers of the digital and technology assets.

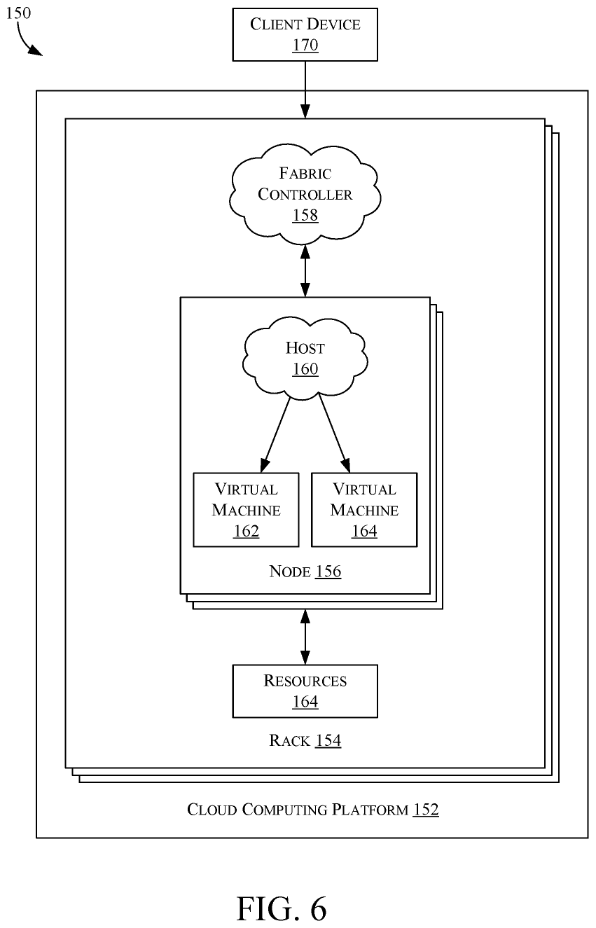

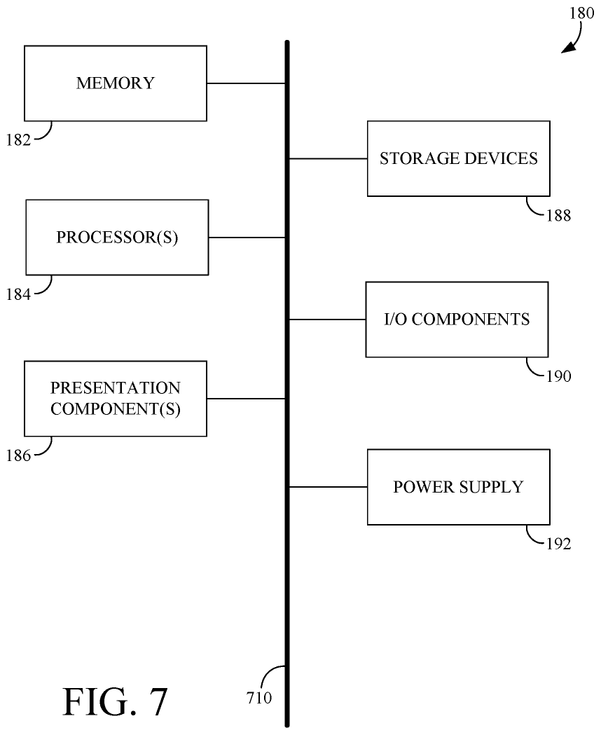

Described below is a smart integrated carbon emissions data analytics engine that accurately quantifies a CO2e footprint of digital and technology assets including software, and enables simulation of a wide range of abatement scenarios for use by technical, business, and sustainability stakeholders to inform the decisions made by the technical, business, and sustainability stakeholders. Any user can leverage the smart integrated carbon emissions data analytics engine, e.g., product designers, architects, innovators, R&D engineers, sustainability specialists, account managers, marketing managers, buyers, data scientists, users, IT specialists, etc., for design and operations optimization as well as monitoring and continuous improvement. The smart integrated carbon emissions data analytics engine can executed on a laptop, either through local execution (see FIG. 7) or cloud-based execution (see FIG. 6).

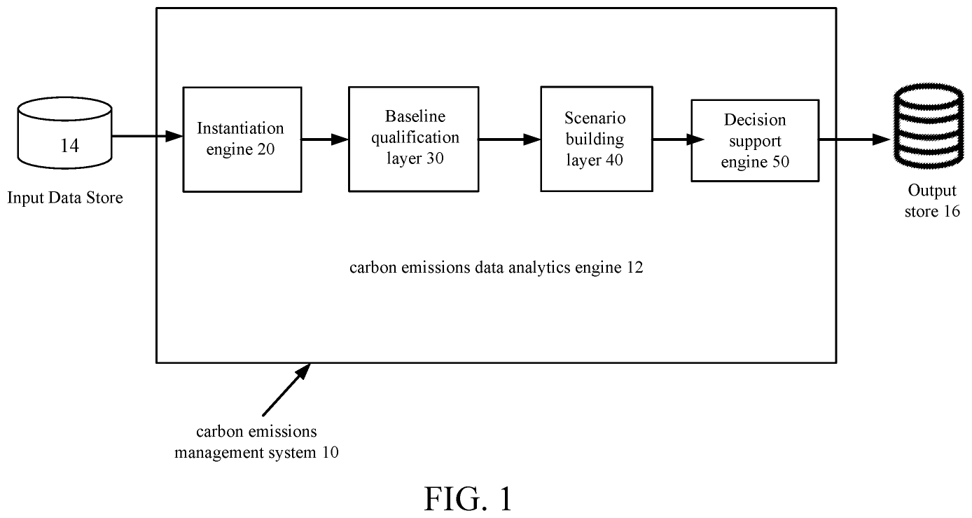

Referring now to FIG. 1, a carbon emissions management system 10 includes a smart integrated carbon emissions data analytics engine 12, as shown. The smart integrated carbon emissions data analytics engine 12 includes an instantiation engine 20 that receives a digital and technology assets design, parameters and key data, such as system consumption data and historical usage data logs all parameters and key data are either system consumption data or historical usage data logs. Here are more specific examples: algorithms, CPU time, process frequency, system latency, etc. The instantiation engine 20 receives these inputs for example from an input store 14. The input store 14 receives inputs from various sources. The instantiation engine 20 reads the inputs from input store 14 (e.g., system design, parameters, key data), verifies their compatibility (data quality checks) and loads a ™ (python.org) model classes. Inputs include sensors and distance to network sensors. Sensors can be watt meters monitoring hardware electricity consumption.

For example, one input source may be from a Life Cycle Assessment (LCA). LCA is a methodology widely used in product management and innovation. LCA can support analyzing environmental aspects and impacts along a lifecycle of digital products. LCA can be an input into the smart integrated carbon emissions data analytics engine 12, e.g., to reflect how a product evolves and dependencies with other assets. LCA presents a static approach which is not aligned with a layered modelling logic required to address the specifics of digital and technology assets emissions. (See https://en.wikipedia.org/wiki/Life-cycle_assessment, incorporated herein by reference.)

Another input source may be from Prometheus an open-source tool for collecting metrics and sending alerts developed by SoundCloud (https://developers.soundcloud.com/blog/prometheus-monitoring-at-soundcloud (incorporated herein by reference.) Prometheus scrapes and stores metrics in an internal time series database or sends data to a remote storage backend. Prometheus allows a user to send queries to retrieve metrics from the storage backend. Prometheus can be accessed by the smart integrated carbon emissions data analytics engine 12 to provide information on how resources are used. However, with Prometheus no link is made to switch from resource usage to CO2e emissions and to associate any variations with root causes/key parameters in order to model abatement scenarios, etc., as it is only a monitoring tool.

Another input source may be from CodeCarbon™ “https://codecarbon.io/.” CodeCarbon™ is a lightweight software package that seamlessly integrates into a python™ codebase. CodeCarbon™ estimates the amount of CO2e produced by cloud or personal computing resources used to execute a specific piece of python™ code. Fundamentally, CodeCarbon™ is a power sensor specifically designed to address python code run. CodeCarbon™ can be an input into the smart integrated carbon emissions data analytics engine 12. However, being solely focused on providing a measurement of the consumption of one piece of code (as opposed to a full digital and technology assets architecture), and furthermore being focused on the python™ coding language, it is too narrow to address the required scope.

Another input source may be from a cloud provider such as Azure (see https://azure.microsoft.com/en-us/) or cloud services managers, or open-source products like Cloud Carbon Footprint™ (see https://www.cloudcarbonfootprint.org/.) These sources can provide power consumption from cloud usage and associated emissions input data. Other data sources may be used. Usually cloud provider data gives CO2e emissions by type of hardware used (generally servers), time and datacenter location, but would focus on the cloud component of the digital asset's architecture, and would not provide a broader model of baseline and potentially improved consumptions and footprint scenarios.

The smart integrated carbon emissions data analytics engine 12 also includes a baseline quantification engine 30 that involves modelling of the digital and technology assets operation and quantification of baseline emissions and power consumption. The smart integrated carbon emissions data analytics engine 12 receives inputs from one or more of the above sources (or other sources) and models the inputs by hardware operation based on digital functionalities (algorithms, applications, operating system, etc.). The smart integrated carbon emissions data analytics engine 12 models product operation, by modelling process functions, allocation functions, transfer functions, and power functions that flow across the digital asset architecture's layers (applicative, OS/container, and hardware). Instantiation engine 20 loads parameters into the model, and the baseline qualification engine 30 performs the computation. In one implementation models are in the form of python™ classes, and an Excel® file (Microsoft Inc. Redmond WA) used as input data store for the prototype that contains all parameters, functions and system design.

The smart integrated carbon emissions data analytics engine 12 receives the model of the product operation (process functions, allocation functions, transfer functions, and power functions) that are input to an abatement scenario building and assessment engine 40. The abatement scenario building and assessment engine 40 defines abatement levers and abatement scenarios, and fine-tunes the digital and technology assets operation determined by the baseline quantification engine 30, in response to modeled abatement scenarios. Levers are any change of parameter value or system design on top of the baseline model. A simulation is executed since the modified parameters and design do not come from an input store (actual data) but from abatement scenarios. Abatement scenarios are defined as scenarios in which the estimated emissions are different from the emissions in a baseline architecture; the user typically seeks to identify scenarios where the emissions are lower than in the baseline but certain scenarios can lead to higher emissions.

The smart integrated carbon emissions data analytics engine 12 also includes a decision-support engine 50 that provides comparisons of abatement scenarios and impact potentials and provides continuous monitoring of the digital and technology assets. The decision-support engine 50 formulates one or more recommendations for improvement of the digital and technology assets. The smart integrated carbon emissions data analytics engine 12 provides user interfaces that allow for an end-to-end visualization and user interaction front-end across all functionalities. The decision support engine runs a set of scenarios and computes a recommendation score based on scenario estimated emissions. The decision support engine comes with a graphical user interface for visualizing results and recommendations. The smart integrated carbon emissions data analytics engine 12 provides comparisons of abatement scenarios and impact potential, and formulated recommendations to store in output store 16.

Definitions of scope emissions as derived from the Greenhouse Gas Protocol, “ghgprotocol.org/” (incorporated herein by reference.) Essentially, scope 1 and 2 are those emissions that are owned or controlled by a company, whereas scope 3 emissions are a consequence of the activities of the company but occur from sources not owned or controlled by it. Scope 1 covers emissions from sources that an organization owns or controls directly—for example from burning fuel in a company's fleet of vehicles (if they're not electrically-powered). Scope 2 are emissions that a company causes indirectly when the energy it purchases and uses is produced. For example, for a company's electric fleet vehicles, the emissions from the generation of the electricity that powers the vehicles are scope 2 emissions.

On the other hand, scope 3 encompasses emissions that are not produced by the company itself, and not the result of activities from assets owned or controlled by the company, but by those that it's indirectly responsible for, up and down its value chain, where value chain is a sequence of activities that a firm performs in order to deliver a valuable product. An example of Scope 3 emissions is when the company buys, uses and/or disposes of products from suppliers. In other words, scope 3 emissions include all sources not within scope 1 and scope 2.

The value proposition of the smart integrated carbon emissions data analytics engine 12 for digital and technology vendors is that it allows those vendors to differentiate and adhere to scope 3 sustainability commitments with a unique eco-design capability. Software eco-design is the capability of design software with low CO2e impact through analysis and recommendation tools, and thus increases “win rate” in response to end-client users and as a consequence increases revenue from monetizing this capability as an add-on to a software sale to end-client users. For digital and technology assets consumers, the smart integrated carbon emissions data analytics engine 12 allows those to have a smaller scope 2 and scope 3 footprint while saving on energy costs.

Key features of the smart integrated carbon emissions data analytics engine 12 include quantification as it covers both scope 2 and scope 3. The smart integrated carbon emissions data analytics engine 12 models hardware operation based on digital functionalities (algorithms, applications, operating system etc.), with the multi levels modelling approach that maps application usage to hardware usage and consumption. The smart integrated carbon emissions data analytics engine 12 enables full variability based on drivers of functionalities and configuration. Abatement scenario simulation enables range of abatement scenarios including any combination of architecture design, code design, technical configuration, operating configuration, implementation efficiency. The smart integrated carbon emissions data analytics engine 12 ensures consistency across all facets of the quantification, e.g., interdependencies, threshold effects and provides input into assessing collateral impacts, e.g., Capex (defined as capital expenses related to developing/deploying a software product), feasibility (defined as engineering R&D complexity), and SLA system level agreement, typically defined as how much software product downtime is allowed in a period of time (e.g., <0.1%)

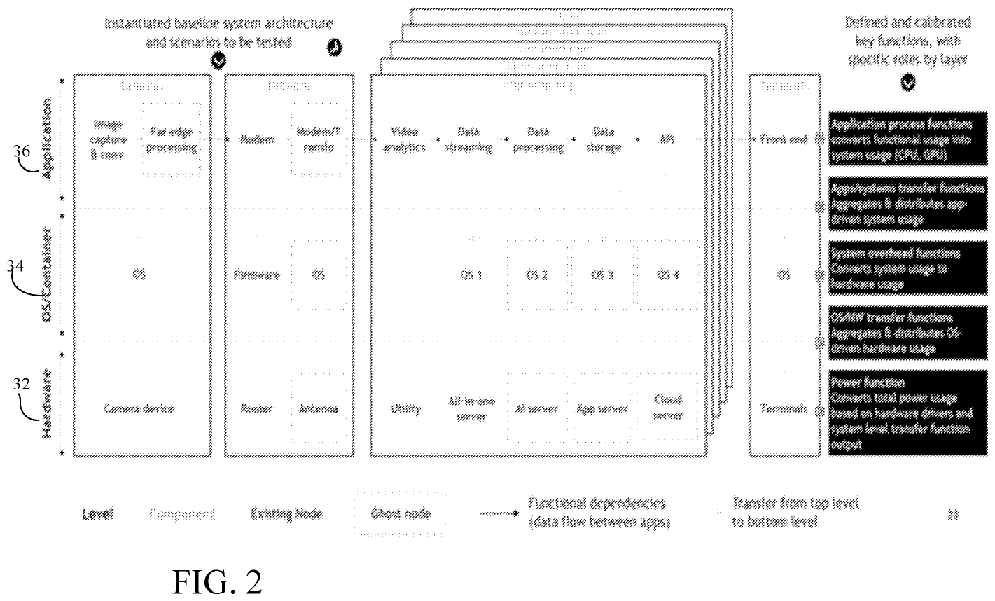

Referring now to FIG. 2, a user interface of the layered modelling approach as applied to an instantiated baseline system architecture is shown, for a specific example of the tool. It's a graphical user interface for uploading input data stores, tuning scenarios and running recommendation engine. The instantiated baseline system architecture includes multiple abatement scenarios that can be tested. Testing abatement scenarios means estimating CO2e impact with the model. Abatement scenarios and scenarios are synonym in this context. These abatement scenarios include edge computing, different degrees of consolidation of the servers, cloud computing, and hybrid versions. The edge computing will be used in the following to explain the instantiated baseline system.

The instantiated baseline system architecture includes three layers, a hardware layer 32, an operating system container layer 34, and an application layer 36. In each of the three layers are components. The hardware layer 32 includes components which can for instance be sensor like such as a camera device or a router device, an antenna, an AI server, an application server, and a cloud server for an edge computing router. The operating system container layer 34 includes an operating system (OS, as well as firmware, associated with the applications and device. The operating system container layer 34 also includes operating system layers (OS 1 to OS 4) associated with the server. The application layer 36 includes cameras that include image capture and conversion software as well as far edge processing associated with the camera device. The application layer 36 also includes network that includes a modem application and modem/transform application associated with the router device and the antenna. The application layer 36 also includes the edge computing layer that includes video analytics, data streaming, data processing, data storage, and application programing interface (API). These applications interface with OS 1 to OS 4 which, in turn, interface with the all-in-one server, the AI server, the application server and the cloud server.

The smart integrated carbon emissions data analytics engine 12 user interface includes the following layers: a product design instantiation layer (processes, nodes, connectors . . . ) layer; a data input layer (parameters, historical logs . . . ) layer, and a product operation modelling layer (process functions, allocation functions, transfer functions, power functions . . . ). The smart integrated carbon emissions data analytics engine 12 user interface also includes levers and options definition (component options, architecture options, location options . . . ) and an abatement scenario definition, a calculator, a user interface, and an end-to-end workflow.

While some prior art solutions are focused on providing information/data about actual digital and technology assets consumption and emissions for monitoring purposes, these prior art solutions do not have smart, layered, variable quantification or allow for abatement scenario modelling, etc., as described above.

Some of the advantages of the solution include enabling business decision makers to measure accurately emissions related to their software products and future products to be deployed, identify drivers and levers they can act on to reduce their software emission footprint which enables full variability based on drivers of functionalities and configuration and adapt their products (architecture design, technical configuration and operating configuration) to achieve their emission footprint goals.

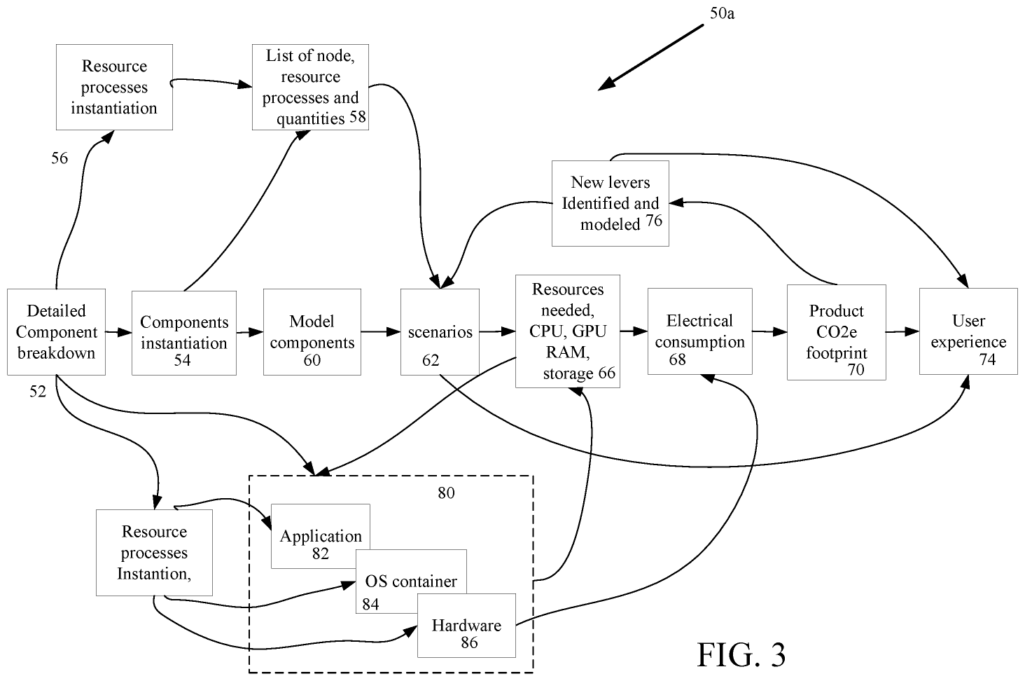

Referring now to FIG. 3, a workflow summary from initial input with all processes definition to generation of the final model's outputs is shown. The diagram shows the three main components of the solution: definition of elements parts (Excel®), analytical engine implemented (python™) and visuals outputs available (User experience) as a flow diagram of a process 50a applicable to the example of FIG. 2, and which is generally applicable.

The process 50a starts with a detailed component breakdown 52 that defines component instantiations 54. The detailed component breakdown 52 also defines resources process instantiation 56. The defined component instantiations 54 and the defined resources process instantiation 56 generates a list of node resources, processes, and quantities 58. The defined component instantiations 54 are used to instantiate the model components 60 and the model components 60 and the generated list of node resources, processes, and quantities 58 are sent to produce scenarios 62.

The produced scenarios 62 compute resources needed 66, e.g., CPU, GPU RAM, storage. The resources needed 66 use transfer functions to convert the resources needed into units of electrical consumption values 68. Electrical consumption values 68 are converted into a Product CO2e footprint 70. The Product CO2e footprint 70 and the produced scenarios 62 are input into user experience 74.

The Product CO2e footprint 70 is reduced by new levers identified and modeled 76. The new levers that are identified and modeled 76 are used to produce the scenarios 62. The new levers identified and modeled 76 are visualized in the user experience 74.

The detailed component breakdown 52 also defines allocation instantiations 80 in a three-level of organization using an application 82, using aggregation functions 84 for the operating system and container and using aggregation functions 86 for hardware. The three level of organization sends output to the defines resources process instantiation 56 and receives input from the scenarios 62 and the detailed component breakdown 52.

The process 50a can be modeled using a spreadsheet, e.g., Excel® and python™ code. The component instantiations 54, the model components 60 the scenarios 62, the resources needed 66, the electrical consumption values 68, and the product CO2e footprint 70 are implemented using python™ code.

The detailed component breakdown 52, the defined resources process instantiation 56, the generated list of node resources, processes, and quantities 58, the new levers, the allocation instantiations 80, i.e., the application 82, aggregation functions 84 for the operating system and container and using aggregation functions 86 for hardware may be defined using the spreadsheet.

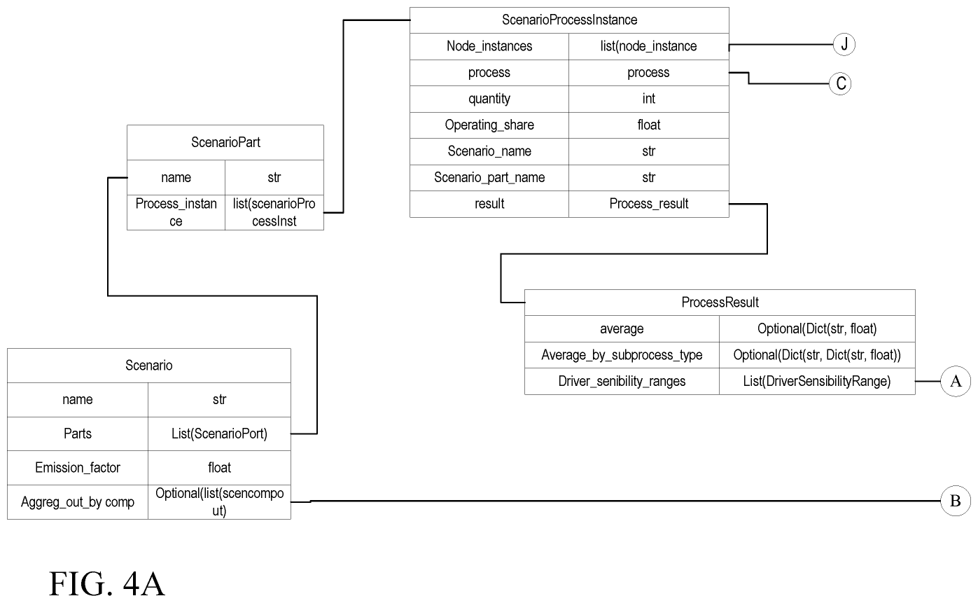

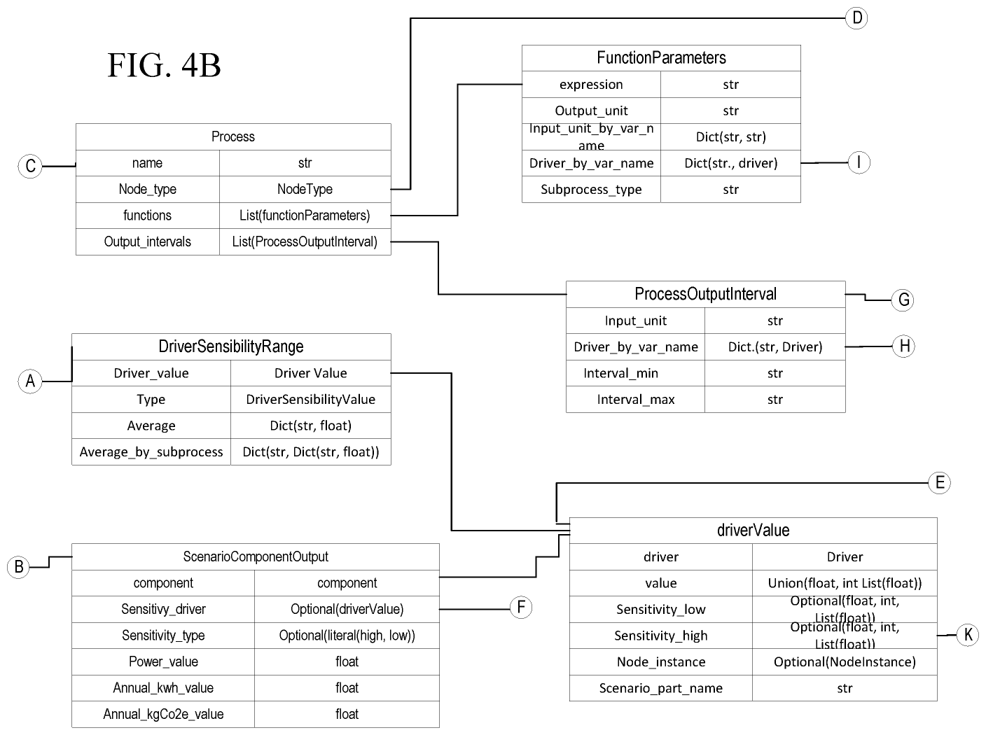

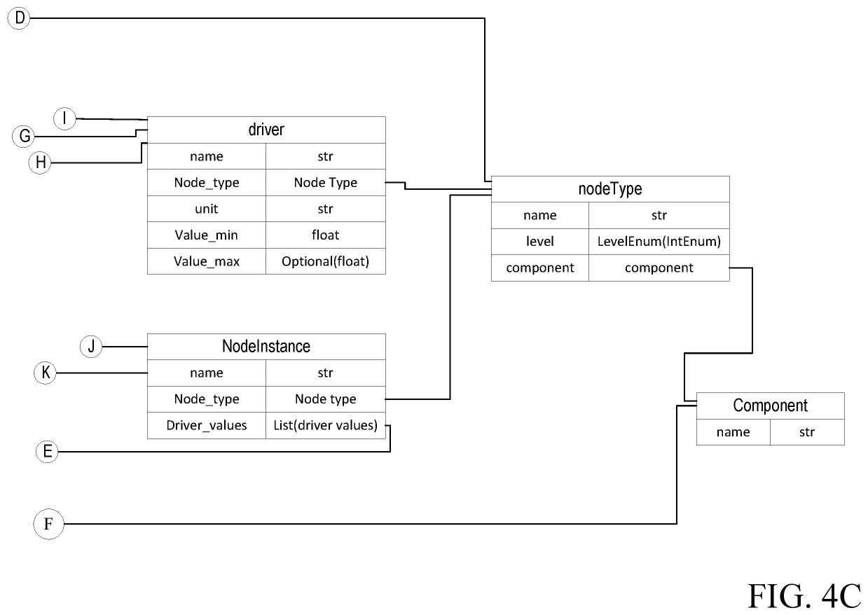

Referring now to FIGS. 4A-4C, data structures that are used with the example of FIG. 2 are shown. Each box represents an entity with its attributes (left column) and types (right column). Types are represented with standard python™ notation (str, float, list, dict, etc.). Links, i.e., lines between entities and attributes (i.e., the boxes) represent inter-dependencies between components in the model. This data model is used by the solution to navigate between the information and compute results.

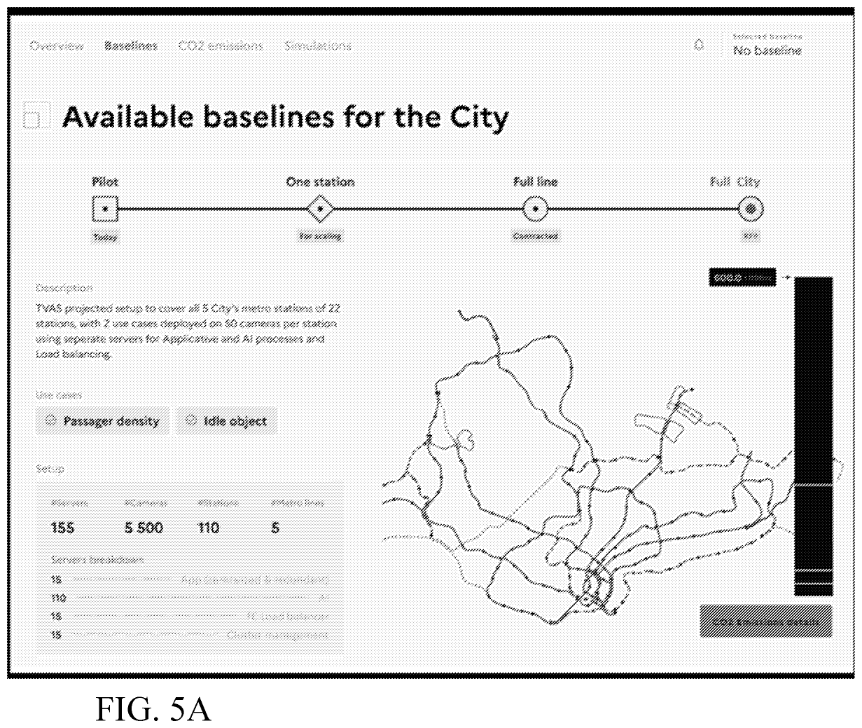

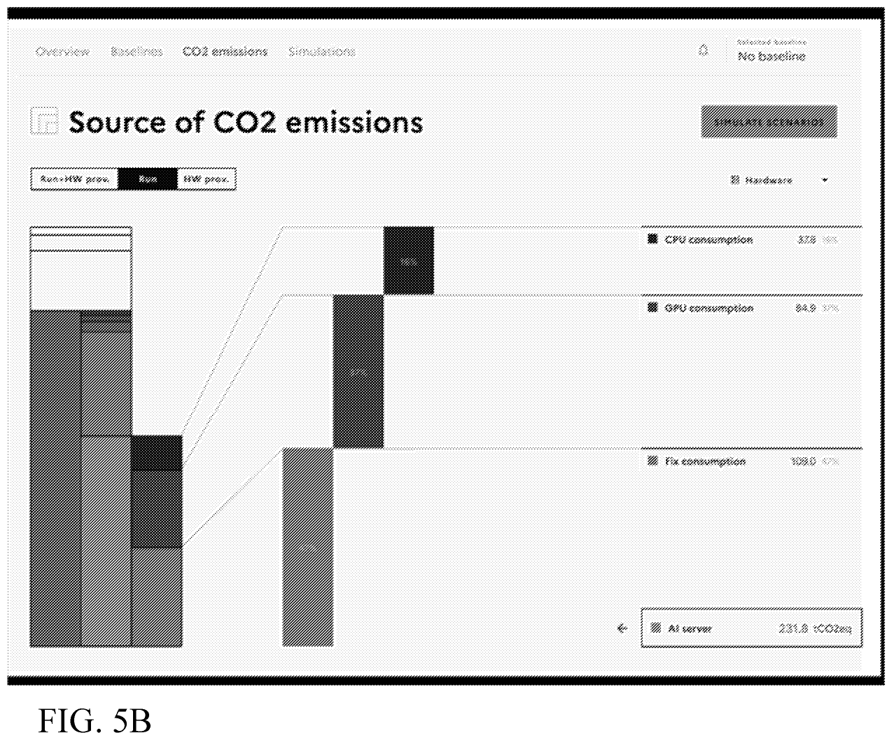

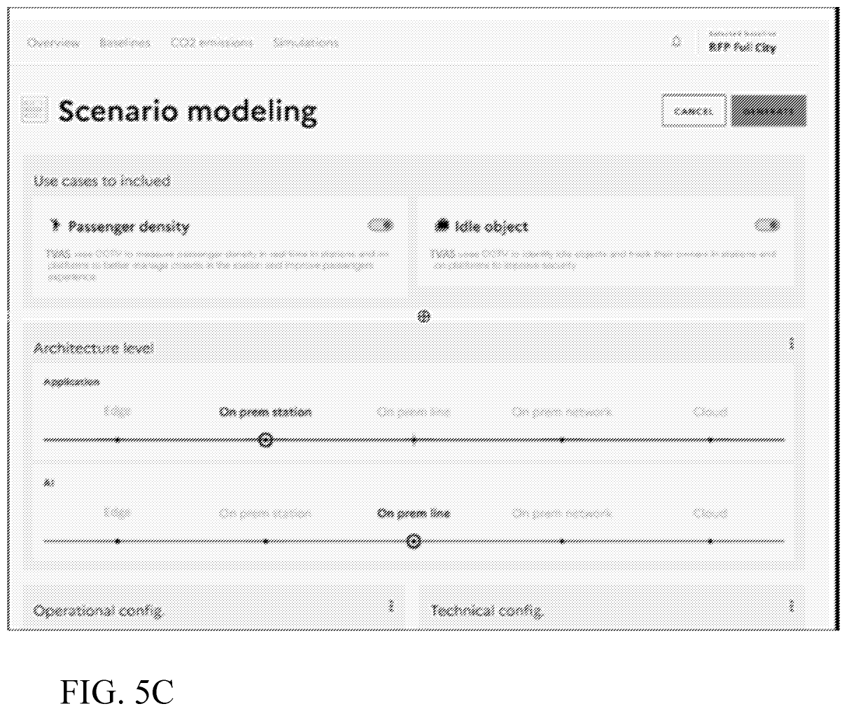

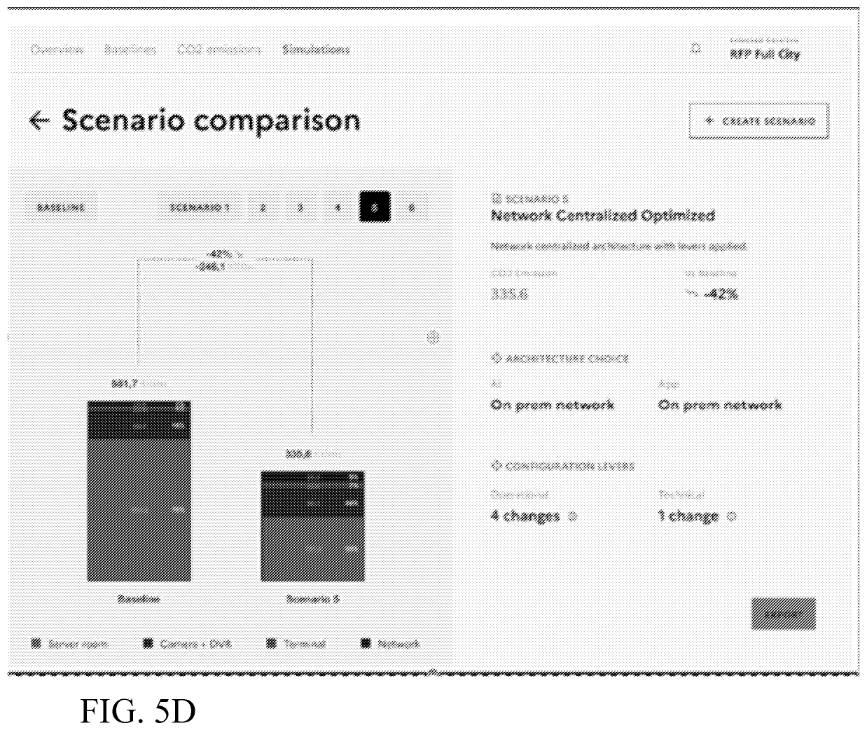

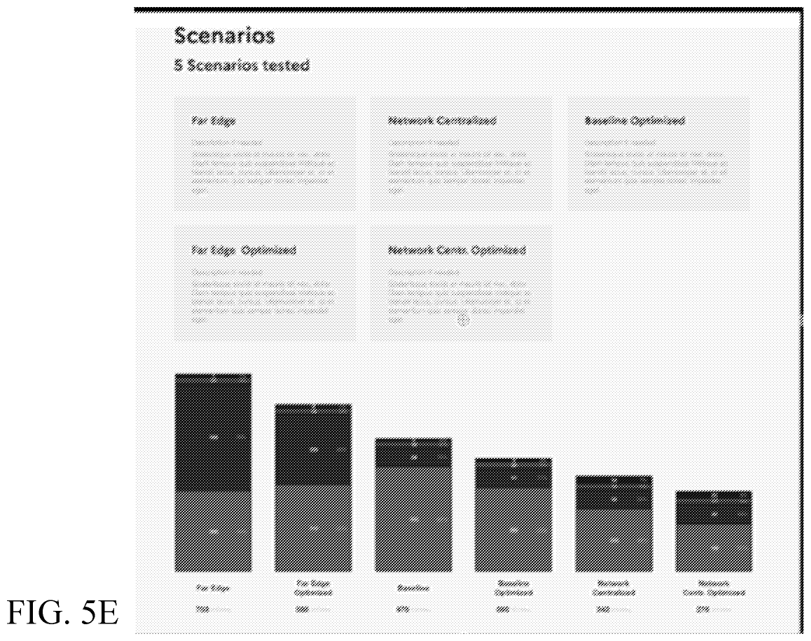

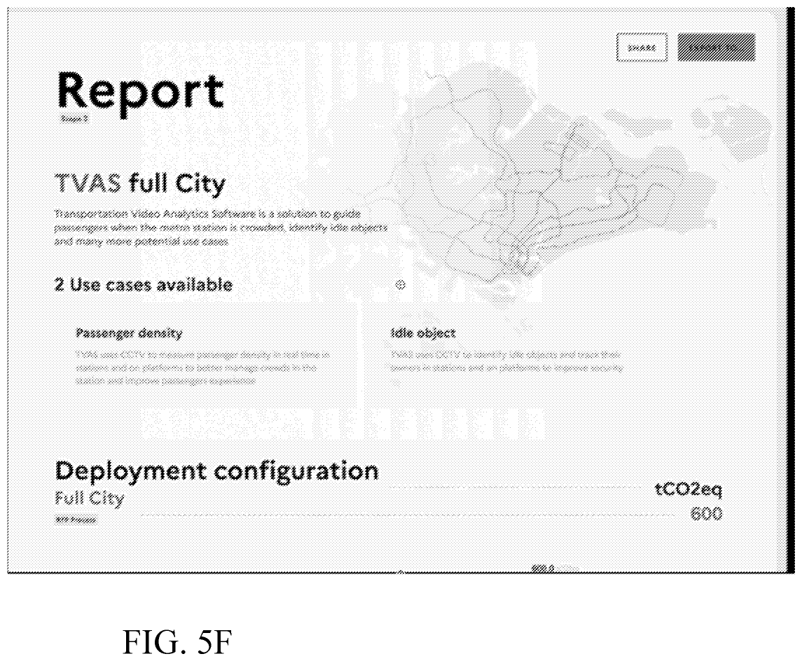

Referring now to FIGS. 5A to 5F, these figures show an extract of the visuals of the solution's user experience design, highlighting (1) offering model management capabilities (input definition, scenario creation, model execution) and (2) output visualization (architecture emissions charts). FIG. 5A shows a structural and technical definition of a baseline design. FIG. 5B shows a deep dive into the baseline footprint quantification. FIG. 5C defines granular scenarios to be simulated. FIG. 5D shows a comparison of the simulated footprints across scenarios examined. FIG. 5E shows a deep dive into and comparison of scenarios and identifying trade-offs. FIG. 5F shows a report. These figures are exemplary of the types that can be provided.

### Example Distributed Computing System Environment

Referring now to FIG. 6, an example distributed computing environment 150 is shown. FIG. 6 shows a high-level architecture of a cloud computing platform 152 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The distributed computing environment 150 includes data centers that includes cloud computing platform 152, rack 154, and node 156 (e.g., computing devices, processing units, or blades) in rack 154. The technical solution environment can be implemented with cloud computing platform 152 that runs cloud services across different data centers and geographic regions. Cloud computing platform 152 can implement fabric controller 158 component for provisioning and managing resource allocation, deployment, upgrade, and management of cloud services. Typically, a cloud computing platform 152 acts to store data or data analytics applications in a distributed manner. Cloud computing platform 152 in a data center can be configured to host and support operation of endpoints of a particular service application. Cloud computing platform 152 may be a public cloud, a private cloud, or a dedicated cloud.

Node 156 can be provisioned with host 160 (e.g., operating system or runtime environment) execution a defined software stack on node 156. Node 156 can also be configured to perform specialized functionality (e.g., compute nodes or storage nodes) within cloud computing platform 152. Node 156 is allocated to run one or more portions of a service application of a tenant. A tenant can refer to a customer utilizing resources of cloud computing platform 152. Service application components of cloud computing platform 152 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 156, nodes 156 may be partitioned into virtual machines (e.g., virtual machine 162 and virtual machine 164). Physical machines can also concurrently run separate service applications. The virtual machines or physical machines can be configured as individualized computing environments that are supported by resources (e.g., hardware resources and software resources) in cloud computing platform 152. It is contemplated that resources can be configured for specific service applications. Further, each service application may be divided into functional portions such that each functional portion is able to run on a separate virtual machine. In cloud computing platform 152, multiple servers may be used to run carbon emissions data analytics applications and perform data storage operations in a cluster. In particular, the servers may perform data operations independently but exposed as a single device referred to as a cluster. Each server in the cluster can be implemented as a node.

Client device 170 may be linked to a service application in cloud computing platform 152. Client device 170 may be any type of computing device, which may correspond to computing device 180 described with reference to FIG. 7, for example, client device 170 can be configured to issue commands to cloud computing platform 152. In embodiments, client device 170 may communicate with data analytics applications through a virtual Internet Protocol (IP) and load balancer or other means that direct communication requests to designated endpoints in cloud computing platform 152. The components of cloud computing platform 152 may communicate with each other over a network (not shown), which may include, without limitation, one or more local area networks (LANs) and/or wide area networks (WANs).

### Example Computing Environment

Referring to FIG. 7, an example operating environment for implementing embodiments of the present invention is shown and designated generally as computing device 180. Essential elements of a computing device 180 or a computer or data processing system are one or more programmable processors 184 for performing actions in accordance with instructions and one or more memory devices 182 for storing instructions and data. Generally, a computer will also include, or be operatively coupled, (via bus, fabric, network, etc.,) to I/O components 190, e.g., display devices, network/communication subsystems, etc. and one or more mass storage devices 188 for storing data and instructions, etc., which are powered by a power supply 192.

Embodiments can be implemented in digital electronic circuitry, or in computer hardware, firmware, software, or in combinations thereof. Embodiments can be implemented in a computer program product tangibly stored in a machine-readable (e.g., computer readable) hardware storage device for execution by a programmable processor; and method actions can be performed by a programmable processor executing a program of executable computer code (executable computer instructions) to perform functions of the invention by operating on input data and generating output. Embodiments can be implemented advantageously in one or more computer programs executable on a programmable system, such as a data processing system that includes at least one programmable processor coupled to receive data and executable computer code from, and to transmit data and executable computer code to, memory, and a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive executable computer code and data from memory, e.g., a read-only memory and/or a random-access memory and/or other hardware storage devices. Generally, a computer will include one or more mass storage devices for storing data files; such devices include magnetic disks, such as internal hard disks and removable disks; magneto-optical disks; and optical disks. Hardware storage devices, e.g., computer readable storage media suitable for tangibly storing non-transitory computer program executable computer code and data, include all forms of volatile memory, e.g., semiconductor random access memory (RAM), all forms of non-volatile memory including, by way of example, semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. The embodiments can be put to various uses, such as educational, job performance enhancement, e.g., sales force and so forth. Nevertheless, it will be understood that various modifications may be made without departing from the scope of the invention.

What is claimed is:

1. A computer system for measuring carbon equivalent emissions from digital and technology assets including software, the computer system comprising:
one or more computer processors; and
computer memory storing a carbon emissions data analytics engine that includes computer-useable instructions that, when executed by the one or more computer processors, cause the one or more computer processors to:
receive a digital and technology assets design and parameters and data including system consumption data and historical usage data logs;
model a baseline operation of the digital and technology design and quantification of baseline emissions and power consumption;
generate by an abatement scenario building and assessment engine, at least two abatement scenario models;
provide at least one comparison of the at least two abatement scenario models;
generate a carbon equivalent emission data analytics recommendation, based on the least one comparison; and
cause display of the carbon equivalent emissions data analytics recommendation.

2. The computer system of claim 1 wherein definitions of scope emissions are provided, and the computer system provides models for scope 1 and 2 which are emissions that are owned or controlled by a company, and scope 3 which are emissions are a consequence of activities of the company but occur from sources not owned or controlled by the company.

3. The computer system of claim 2 further including an analytics recommendation engine that produces at least one recommendation that addresses scope two and scope three emissions.

4. The computer system of claim 1 wherein the carbon emissions data analytics engine receives inputs from one or more input sources and models the inputs by hardware operation based on digital functionalities including at least one of algorithms, applications, and operating systems.

5. The computer system of claim 1 wherein the carbon emissions data analytics engine models digital and technology assets including software operation, by modelling process functions, allocation functions, transfer functions, and power functions.

6. The computer system of claim 1 wherein the carbon emissions data analytics engine receives the model of the digital and technology assets including software operation including process functions, allocation functions, transfer functions, and power functions, which are inputs to a baseline quantification and the abatement scenario building and assessment engine.

7. The computer system of claim 1 wherein the abatement scenario building and assessment engine defines abatement levers and abatement scenarios, and fine-tunes the digital and technology assets operation determined by a baseline quantification engine, in response to modeled abatement scenarios.

8. The computer system of claim 1 wherein the carbon emissions data analytics engine further comprises:
a decision-support engine that provides comparisons of abatement scenarios and impact potentials, and provides continuous monitoring of the digital and technology assets.

9. The computer system of claim 8 wherein the decision-support engine formulates one or more recommendations for improvement of the digital and technology assets.

10. The computer system of claim 1 wherein the carbon emissions data analytics engine provides user interfaces that renders a layered baseline system architecture that includes a plurality of layers, including at least a hardware layer, an operating system container layer, and an application layer.

11. A computer implemented method for measuring carbon equivalent emissions from digital and technology assets including software, the method comprising:
receiving by one or more computer processors in communication with a computer memory that store a carbon emissions data analytics engine that includes computer-useable instructions that, when executed by the one or more computer processors, cause the one or more computer processors to execute the actions of:
receiving a digital and technology assets design and parameters and data including system consumption data and historical usage data logs;
modeling a baseline operation of the digital and technology design and quantification of baseline emissions and power consumption;
generating by an abatement scenario building and assessment engine, at least two abatement scenario models;
providing at least one comparison of the at least two abatement scenario models;
generating a carbon equivalent emission data analytics recommendation, based on the least one comparison; and
causing display of the carbon equivalent emissions data analytics recommendation.

12. The method of claim 11 wherein definitions of scope emissions are provided, and the one or more computer processors provides models for scope 1 and 2 which are emissions that are owned or controlled by a company, and scope 3 which are emissions are a consequence of activities of the company but occur from sources not owned or controlled by the company.

13. The method of claim 12 further comprising:
generating at least one recommendation that addresses scope two and scope three emissions.

14. The method of claim 11 further comprising:
receiving inputs from one or more input sources; and
modeling the inputs by hardware operation based on digital functionalities including at least one of algorithms, applications, and operating systems.

15. The method of claim 11 wherein modeling digital and technology assets including software operation, comprises:
modelling process functions, allocation functions, transfer functions, and power functions.

16. The method of claim 11 further comprising:
receiving the model of the digital and technology assets including software operation including process functions, allocation functions, transfer functions, and power functions, which are inputs to the abatement scenario building and assessment engine.

17. The method of claim 11 wherein the abatement scenario building and assessment engine defines abatement levers and abatement scenarios, and fine-tunes the digital and technology assets operation determined by a baseline quantification engine, in response to modeled abatement scenarios.

18. The method of claim 11 wherein the carbon emissions data analytics engine further comprises:
comparing by a decision-support engine that provides comparisons of abatement scenarios and impact potentials and enables continuous monitoring of the digital and technology assets.

19. The method of claim 18 wherein the decision-support engine formulates one or more recommendations for improvement of the digital and technology assets.

20. The method of claim 11 wherein the carbon emissions data analytics engine further comprises:
providing a user interface that renders a layered baseline system architecture that includes a plurality of layers, including at least a hardware layer, an operating system container layer, and an application layer.

21. A non-transitory computer readable storage medium for measuring carbon equivalent emissions from digital and technology assets including software, the computer readable storage medium storing a carbon emissions data analytics engine that includes computer-useable instructions that, when executed by the one or more computer processors, cause the one or more computer processors to:
receive a digital and technology assets design and parameters and data including system consumption data and historical usage data logs;
model a baseline operation of the digital and technology design and quantification of baseline emissions and power consumption;
generate by an abatement scenario building and assessment engine, at least two abatement scenario models;
provide at least one comparison of the at least two abatement scenario models;
generate a carbon equivalent emission data analytics recommendation, based on the least one comparison; and
cause display of the carbon equivalent emissions data analytics recommendation.

22. The non-transitory computer readable storage medium of claim 21 wherein definitions of scope emissions are provided, and the computer-useable instructions provides models for scope 1 and 2 which are emissions that are owned or controlled by a company, and scope 3 which are emissions are a consequence of activities of the company but occur from sources not owned or controlled by the company.

23. The non-transitory computer readable storage medium of claim 22 further including an analytics recommendation engine that produces at least one recommendation that addresses scope two and scope three emissions.
